(19) United States
(12) Patent Application Publication
(10) Pub. No.: US 2019/0299162 A1
(43) Pub. Date: Oct. 3, 2019

(54) SYSTEMS AND METHODS FOR TREATING HIGH SULFATE WATER AND INJECTING TREATED WATER

(71) Applicant: Chevron U.S.A. Inc., San Ramon, CA (US)

(72) Inventor: Cheng Chen, Richmond, TX (US)

(21) Appl. No.: 15/940,401

(22) Filed: Mar. 29, 2018

(51) Int. Cl. B01D 61/02; B01D 61/04; B01D 61/08; C02F 1/44; E21B 43/40

(52) U.S. Cl. CPC B01D 61/022; B01D 61/027; B01D 61/025; B01D 61/04; B01D 61/08; C02F 2101/101; C02F 1/442; E21B 43/40; B01D 2311/08; B01D 2317/022; C02F 1/441

(57) ABSTRACT

A method for treating water high in sulfate includes passing the water at a temperature of 10° C. to 45° C. through a nanofiltration membrane module and a reverse osmosis membrane module in series such that the retentate stream from the nanofiltration membrane module is fed to the reverse osmosis membrane module. A first permeate stream from the nanofiltration membrane module has at least 90% lower sulfate content than the feed stream. A second permeate stream from the reverse osmosis membrane module has at least 95% lower sulfate content than the retentate stream from the nanofiltration membrane module. The first and second permeate streams are combined to form a treated stream containing less than 40 ppm sulfate. A system including the nanofiltration and reverse osmosis membrane modules in series is also disclosed.

### FIELD

The present disclosure relates generally to the field of water treatment methods, particularly for removing sulfate from water. The present disclosure further relates generally to the field of water injection into an oil and gas reservoir to enhance production.

### BACKGROUND

In offshore waterflood operations, seawater is often injected into an oil and gas reservoir to increase the reservoir pressure and thus enhance production of oil and gas from the reservoir. When the seawater being injected has a high sulfate content and the formation water present in the formation contains barium, barium sulfate scale can be formed. When sulfate reducing bacteria are being introduced into the reservoir, injecting seawater having a high sulfate content can also result in severe reservoir souring issues. In some cases, very stringent requirements for sulfate content must be applied to seawater for use in waterflood operations. In some cases, for example, sulfate content is limited to less than 10 ppm in seawater injection water at all times. To achieve this, two-pass sulfate removal membrane (SRM) units are used. The use of a two-pass system increases both operating expense and capital expense as well as footprint on the offshore platform as compared with a one-pass membrane system. The use of a two-pass system undesirably involves additional membranes, an additional feed pump, lower recovery, additional chemical dosage, membrane cleaning and maintenance.

There exists a need for methods and systems that remove sulfate from water for offshore waterflood operations in a simpler, less costly manner.

### SUMMARY

In one aspect, the disclosure relates to a method for treating water high in sulfate. The method includes passing a feed stream of water having an initial sulfate content greater than 100 ppm at a temperature of between 10° C. and 45° C. through a nanofiltration membrane module and a reverse osmosis membrane module in series such that a first retentate stream from the nanofiltration membrane module is fed to the reverse osmosis membrane module. A first permeate stream produced from the nanofiltration membrane module has at least 90% lower sulfate content, at least 50% lower magnesium content and at least 30% lower calcium content with respect to a sulfate, magnesium, and calcium content, respectively, in the feed stream. The first retentate stream is passed to the reverse osmosis membrane module to produce a second permeate stream having at least 95% lower sulfate content, at least 90% lower magnesium content and at least 90% lower calcium content with respect to a sulfate, magnesium, and calcium content, respectively, in the first retentate stream. The first and second permeate streams are combined to form a treated stream containing less than 40 ppm sulfate. A second retentate stream from the reverse osmosis membrane module is removed as a reject stream.

In another aspect, the disclosure relates to a system for treating water high in sulfate. The system includes a nanofiltration membrane module for receiving a feed stream of water having an initial sulfate content greater than 100 ppm and forming a first permeate stream and a first retentate stream; a reverse osmosis membrane module located such that the first retentate stream from the nanofiltration membrane module is fed to the reverse osmosis membrane module and wherein the reverse osmosis membrane module forms a second permeate stream and a second retentate stream; and a conduit in which the first permeate stream and the second permeate stream are combined to form a treated stream containing less than 40 ppm sulfate.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 is a schematic diagram of a one-pass sulfate removal membrane system in accordance with the prior art.

FIG. 2 is a schematic diagram of a two-pass sulfate removal membrane system in accordance with the prior art.

FIG. 3 is a schematic diagram of a two-pass sulfate removal-reverse osmosis membrane system in accordance with certain example embodiments.

FIG. 4 is a schematic diagram of a two-pass sulfate removal-reverse osmosis membrane system in accordance with certain example embodiments.

### DETAILED DESCRIPTION

Typically, in sulfate removal units, there are two or three stages in each membrane pass depending on the target percent recovery. By “percent recovery” is meant the percentage of feed water which becomes permeate.

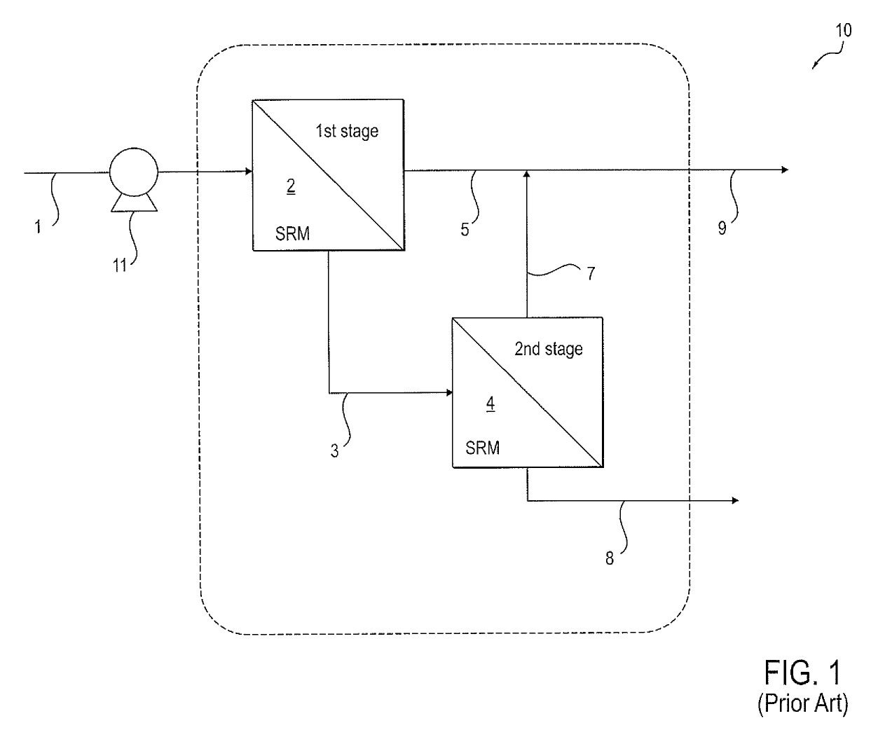

Referring to FIG. 1, a single pass system 10 is shown according to the prior art. A feed stream 1 is fed to a first stage nanofiltration SRM 2 using a feed pump 11 via an inlet to the retentate side of the membrane 2. A retentate stream 3, being concentrated in sulfate is fed to a second stage nanofiltration SRM 4. Again, a retentate stream 8, being concentrated in sulfate is disposed of as waste. A permeate stream 5 from the first stage nanofiltration SRM 2, being depleted in sulfate, is combined with another permeate stream 7 from the second stage nanofiltration SRM 4 to form a treated stream 9. Both the first stage SRM 2 and second stage SRM 4 are within a single pass.

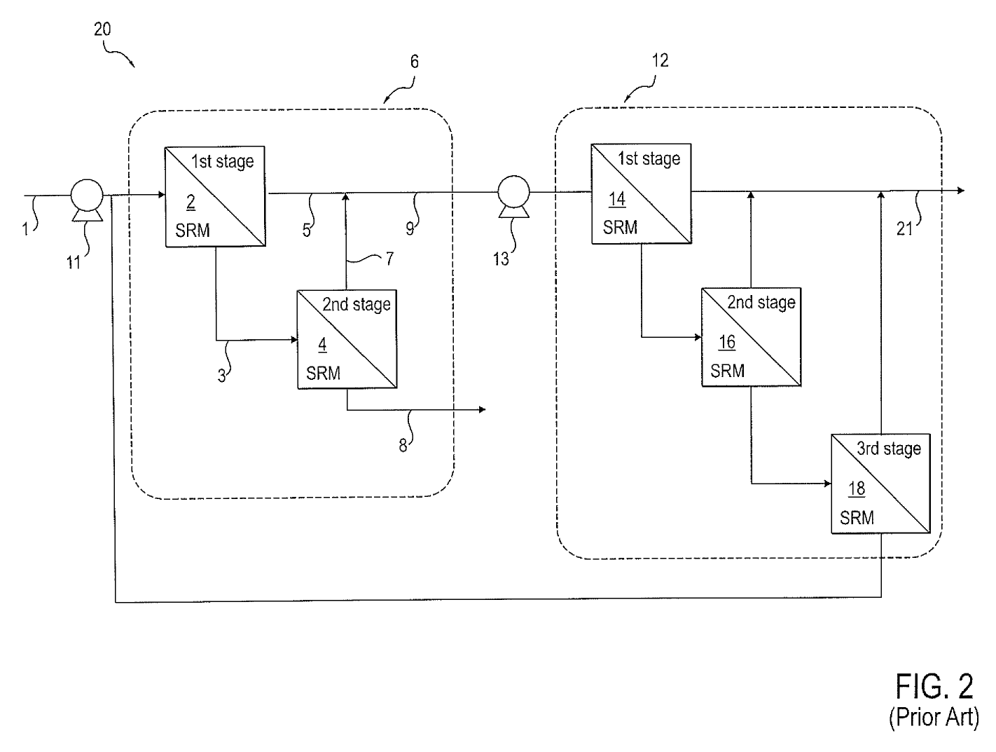

Standard seawater sulfate removal membranes (SRM), which are nanofiltration (NF) membranes, cannot meet sulfate requirements in a single pass (one-pass) system. Therefore, a two-pass system is typically required. Referring to FIG. 2, a two-pass system 20 is shown according to the prior art. The single pass system 10 shown in FIG. 1 is the first pass 6 and a pump delivers the stream 9 to a second pass 12 including three stages of SRMs, 14, 16 and 18, resulting in a combined treated stream 21.

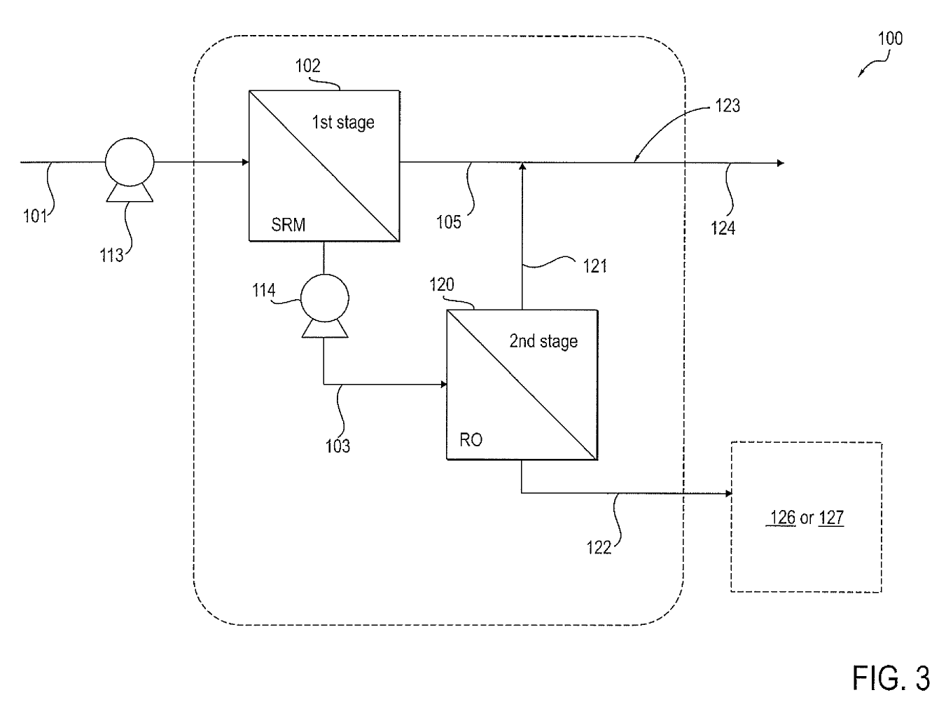

In one embodiment, a nanofiltration membrane module, also referred to as a nanofiltration SRM, is used as a first stage and a seawater reverse osmosis (RO) membrane having higher sulfate rejection than the nanofiltration SRM is used as a second stage to improve sulfate rejection. Referring to FIG. 3, a two-pass system 100 is shown according to embodiments. A nanofiltration membrane module 102 receives a feed stream of high sulfate water 101 for treatment. The feed stream of water 101 can be produced water associated with oil and/or gas production, flowback water associated with oil and/or gas operations, aquifer water and/or seawater. The feed stream 101 has an initial sulfate content greater than 100 ppm, even greater than 500 ppm. The nanofiltration membrane module 102 receives the feed stream and forms a first permeate stream 105 and a first retentate stream 103. A feed pump 113 can be used for delivering the feed stream 101 to the nanofiltration membrane module 102.

A reverse osmosis membrane module 120 is located downstream and in series with the nanofiltration membrane module 102 such that the first retentate stream 105 from the nanofiltration membrane module 102 is fed to the reverse osmosis membrane module 120. In one embodiment, a booster pump 114 is located between a retentate outlet of the nanofiltration membrane module 102 and an inlet of the reverse osmosis membrane module 120.

The reverse osmosis membrane module 120 receives the first retentate stream 103 and forms a second permeate stream 121 and a second retentate stream 122. The first permeate stream 105 and the second permeate stream 121 are combined in a conduit 123 to form a treated stream 124. The treated stream 124 can containing less than 40 ppm sulfate, even less than 20 ppm sulfate, and even less than 10 ppm sulfate.

Each of the nanofiltration membrane module 102 and the reverse osmosis membrane module 120 can have a plurality of membrane elements therein (not shown). In one embodiment, the reverse osmosis membrane module 120 has a number of membrane elements that is greater than 40% of a number of membrane elements in the nanofiltration membrane module 102. Typically, each membrane module will contain about 6 to 8 membrane elements depending on the permeate flux rate.

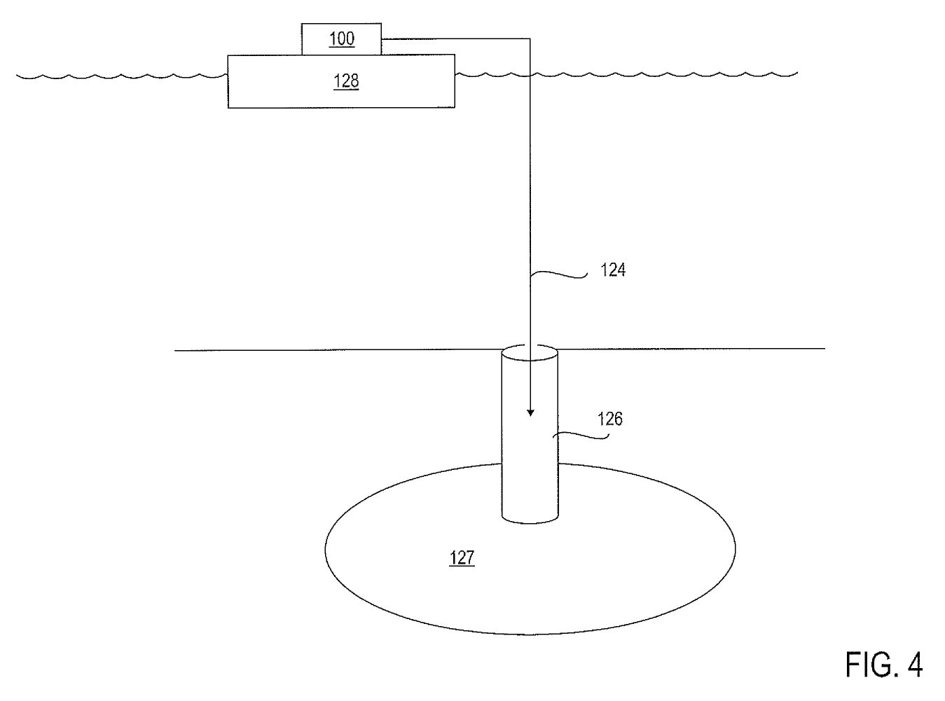

In some embodiments, shown in FIG. 4, the system 100 is located on an offshore oil and/or gas production platform or vessel 128 such that the method occurs on the offshore oil and/or gas production platform or vessel 128. In some embodiments, the treated stream 124 is injected through an injection well 126 into an oil and/or gas reservoir 127 without treating the stream 124 further prior to injection. In some embodiments, the treated stream 124 is injected through the injection well 126 into the oil and/or gas reservoir 127 without the addition of a biocidal agent to any of the above described streams during the method prior to injection.

In one embodiment, a method for treating water high in sulfate includes passing the feed stream of water 101 to the nanofiltration membrane module 102 at a temperature of between 10° C. and 45° C. The first permeate stream 105 produced from the nanofiltration membrane module 102 has at least 90% lower sulfate content, at least 50% lower magnesium content and at least 30% lower calcium content with respect to a sulfate, magnesium, and calcium content, respectively, in the feed stream 101. The first retentate stream 103 is passed to the reverse osmosis membrane module 120 to produce a second permeate stream 121 having at least 95% lower sulfate content, at least 90% lower magnesium content and at least 90% lower calcium content with respect to a sulfate, magnesium, and calcium content, respectively, in the first retentate stream 103. The first and second permeate streams 105 and 121 are combined to form a treated stream 124 containing less than 40 ppm sulfate. The second retentate stream 122 from the reverse osmosis membrane module 120 is removed as a reject stream.

In some embodiments, energy from the reject stream 122 can be recovered using an energy recovery turbine 126 or a pressure exchanger 127.

The percent recovery of the treated stream 124 relative to the feed stream 101 can be greater than 50%. The percent recovery of the first permeate stream 105 from the nanofiltration membrane module 102 relative to the feed stream 101 can be less than 60%. The percent recovery of the second permeate stream 121 relative to the first retentate stream 103 can be greater than 40%.

The treated stream 124 can have a salinity up to 60% lower than an initial salinity of the feed stream 101.

In some embodiments, the feed stream of water 101 can be pretreated such that the feed stream 101 contains no greater than 50,000 ppm total dissolved solids, 5,000 ppm sulfate, 2,000 ppm calcium and 2,000 ppm magnesium prior to contacting the nanofiltration membrane module 102. The pretreatment can be done by a suitable method selected from particle filtration, ultrafiltration membranes, clarifying, softening, primary, secondary and tertiary deoiling and/or desanding, using a pretreatment module selected from particle filters, ultrafiltration membranes, clarifiers, softeners, primary, secondary and tertiary deoiling equipment and/or desanding equipment. Chemical treatment including acid, caustic and anti-scalant may be used to mitigate membrane scaling.

### EXAMPLES

### Example 1

The configuration shown in FIG. 3 was used in this example. Table 1 lists the operating parameters and properties of the various streams. The test was conducted in a lab using an in-house membrane test skid. The water sample was directly received from an offshore oilfield. The membrane skid was operated using a Hydranautics Nano-SW nanofiltration membrane element (available from Hydranautics, a Nitto Group Company, Oceanside, Calif.) to produce the first permeate stream. Then the membrane was switched to a seawater reverse osmosis membrane element to produce the second permeate stream using the retentate from the first membrane test as the feed stream. Finally, the two permeate streams were mixed together in the permeate tank. The test was conducted at 32° C. with first stage water recovery of 40% and second stage water recovery of 33% (total recovery of 60%).

The data in Table 1 shows that the sulfate level was reduced to about 10.6 ppm using seawater RO membranes in the second stage. By comparison, when the same Hydranautics Nano-SW membrane was used in the second stage, the lab tested sulfate in the combined permeate stream was about 18 mg/L. There was about a 41% reduction of sulfate when the Hydranautics Nano-SW membrane was replaced by the seawater RO membranes.

TABLE 1

| | | 1st stage | | |
|---|---|---|---|---|
| | | SRM Permeate | 2nd stage RO Permeate | |
| | Feed | Hydranautics | Hydranautics | Seawater RO |
| | water | Nano-SW | Nano-SW | membrane |
| Temperature | 90.7 | 90.7 | 95 | 92.3 |
| (° F.) | | | | |
| SO₄ (mg/L) | 3005.5 | 11.4 | 31.23 | 9.06 |
| Cl (mg/L) | 19800 | 15634.3 | 309.2 | 180.8 |
| Recovery | | 40% | 33% | 33% |
| ratio | | | | |
| SO₄ in | | | 18.01 | 10.62 |
| combined | | | | |
| permeate | | | | |
| (mg/L) | | | | |
| Cl in | | | 17,700 | 10,483 |
| combined | | | | |
| permeate | | | | |
| (mg/L) | | | | |
| Calculated | | | 29,599.2 | 17,297 |
| salinity of | | | | |
| combined | | | | |
| permeate | | | | |
| (mg/L) | | | | |

### Example 2

A simulation of a nanofiltration and reverse osmosis membrane process using the configuration shown in FIG. 3 was run using software programs specifically designed by membrane companies for the specific membrane used and compared to the prior art configuration shown in FIG. 1. Winflows software (obtained from General Electric Company, Boston, Mass.) was used to simulate SWSR-440 seawater sulfate removal nanofiltration elements (available from SUEZ Water Technologies & Solutions, Trevose, Pa.) and AD-440 thin film reverse osmosis membrane elements (available from SUEZ Water Technologies & Solutions). Simulated water was used for membrane calculations. The recovery was set at 70% and the temperature was set at 90° F.

Table 2 lists the TDS of various ions in mg/L for each of the feed stream, the two stage NF permeate stream and the hybrid NF and RO membrane stream. As can be seen from the data in Table 2, the sulfate concentration in the permeate was significantly reduced from about 9.5 mg/L to about 5.8 mg/L using the hybrid NF and RO membrane design (shown in FIG. 3). There was nearly a 40% reduction of sulfate in the final permeate stream 124.

TABLE 2

| | TDS, mg/L | | |
|---|---|---|---|
| | | | Permeate stream |
| | | Permeate stream | 124 in FIG. 3 (1st |
| | | 9 in FIG. 1 (Two | stage NF and 2nd |
| | Feed | stage NF) | stage RO) |
| Calcium | 434.00 | 96.88 | 48.20 |
| Magnesium | 1309.00 | 65.21 | 32.08 |
| Sodium | 12704.57 | 12439.62 | 8027.45 |
| Potassium | 377.00 | 345.70 | 217.04 |
| Ammonium (NH₄) | 0.00 | 0.00 | 0.00 |
| Barium | 0.00 | 0.00 | 0.00 |
| Strontium | 8.00 | 1.80 | 0.90 |
| Iron | 0.00 | 0.00 | 0.00 |
| Manganese | 0.00 | 0.00 | 0.00 |
| Sulfate | 2964.00 | 9.50 | 5.81 |
| Chloride | 22119.75 | 19668.62 | 12638.44 |
| Fluoride | 0.00 | 0.00 | 0.00 |
| Nitrate | 0.00 | 0.00 | 0.00 |
| Bromide | 91.00 | 89.08 | 57.57 |
| Phosphate | 0.00 | 0.00 | 0.00 |
| Boron | 4.00 | 4.00 | 2.85 |
| Silica | 5.00 | 5.00 | 3.28 |
| Hydrogen Sulfide | 0.00 | 0.00 | 0.00 |
| Bicarbonate | 285.41 | 239.06 | 144.98 |
| Carbon Dioxide | 0.99 | 1.77 | 1.33 |
| Carbonate | 9.09 | 3.70 | 1.87 |
| TDS, mg/l | 40310.81 | 32968.16 | 21180.47 |

Overall low sulfate targets can be achieved through the use of the systems and methods disclosed herein. Operating expense, capital expense, footprint and/or weight can advantageously be reduced.

It should be noted that only the components relevant to the disclosure are shown in the figures, and that many other components normally part of a water treatment system are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

What is claimed is:

1. A method for treating water high in sulfate, comprising:
a. passing a feed stream of water having an initial sulfate content greater than 100 ppm at a temperature of between 10° C. and 45° C. through a nanofiltration membrane module and a reverse osmosis membrane module in series such that a first retentate stream from the nanofiltration membrane module is fed to the reverse osmosis membrane module;
b. producing a first permeate stream from the nanofiltration membrane module wherein the first permeate stream has at least 90% lower sulfate content, at least 50% lower magnesium content and at least 30% lower calcium content with respect to a sulfate, magnesium, and calcium content, respectively, in the feed stream;
c. passing the first retentate stream to the reverse osmosis membrane module to produce a second permeate stream having at least 95% lower sulfate content, at least 90% lower magnesium content and at least 90% lower calcium content with respect to a sulfate, magnesium, and calcium content, respectively, in the first retentate stream;
d. combining the first and second permeate streams to form a treated stream containing less than 40 ppm sulfate; and
e. removing a second retentate stream from the reverse osmosis membrane module as a reject stream.

2. The method of claim 1 wherein the initial sulfate content of the water is greater than 500 ppm.

3. The method of claim 1 wherein the treated stream contains less than 10 ppm sulfate.

4. The method of claim 1 wherein the percent recovery of the treated stream relative to the feed stream is greater than 50%.

5. The method of claim 1 wherein the percent recovery of the first permeate stream from the nanofiltration membrane module relative to the feed stream is less than 60%.

6. The method of claim 1 wherein the percent recovery of the second permeate stream relative to the first retentate stream is greater than 40%.

7. The method of claim 1 wherein the treated stream has a salinity up to 60% lower than an initial salinity of the feed stream.

8. The method of claim 1 wherein the feed stream of water comprises produced water associated with oil and/or gas production, flowback water associated with oil and/or gas operations, aquifer water and/or seawater.

9. The method of claim 1 wherein the method occurs on an offshore oil and/or gas production platform or vessel.

10. The method of claim 1 further comprising pretreating the water prior to step (a) such that the feed stream contains no greater than 50,000 ppm total dissolved solids, 5,000 ppm sulfate, 2,000 ppm calcium and 2,000 ppm magnesium.

11. The method of claim 1 wherein the pretreating is done by a pretreatment method selected from the group consisting of particle filtration, ultrafiltration membranes, clarifying, softening, primary, secondary and tertiary deoiling, desanding, and combinations thereof.

12. The method of claim 1 further comprising injecting the treated stream through an injection well into an oil and/or gas reservoir without treating the treated stream further prior to injection.

13. The method of claim 1 further comprising injecting the treated stream through an injection well into an oil and/or gas reservoir without the addition of a biocidal agent to any stream during the method.

14. A system for treating water high in sulfate, comprising:
a. a nanofiltration membrane module for receiving a feed stream of water having an initial sulfate content greater than 100 ppm and forming a first permeate stream and a first retentate stream;
b. a reverse osmosis membrane module located such that the first retentate stream from the nanofiltration membrane module is fed to the reverse osmosis membrane module and wherein the reverse osmosis membrane module forms a second permeate stream and a second retentate stream; and
c. a conduit in which the first permeate stream and the second permeate stream are combined to form a treated stream containing less than 40 ppm sulfate.

15. The system of claim 14 further comprising a feed pump for delivering the feed stream to the nanofiltration membrane module.

16. The system of claim 14 wherein the feed stream of water comprises produced water associated with oil and/or gas production, aquifer water and/or seawater.

17. The system of claim 14 further comprising a pretreatment module selected from the group consisting of particle filters, ultrafiltration membranes, clarifiers, softeners, primary, secondary and tertiary deoiling equipment, desanding equipment, and combinations thereof.

18. The system of claim 14 further comprising an injection well in an oil and/or gas reservoir for injecting the treated stream into the oil and/or gas reservoir.

19. The system of claim 14 wherein each of the nanofiltration membrane module and the reverse osmosis membrane module have a plurality of membrane elements.

20. The system of claim 19 wherein the reverse osmosis membrane module has a number of membrane elements that is greater than 40% of a number of membrane elements in the nanofiltration membrane module.

21. The system of claim 14 wherein the system is located on an offshore oil and/or gas production platform or vessel.

22. The system of claim 14 further comprising a booster pump located between a retentate outlet of the nanofiltration membrane module and an inlet of the reverse osmosis membrane module.

23. The system of claim 14 further comprising an energy recovery turbine or a pressure exchanger to recover energy from a reject stream from the reverse osmosis membrane module.
